(19) United States
(12) Patent Application Publication
(10) Pub. No.: US 2010/0145787 A1
(43) Pub. Date: Jun. 10, 2010

(54) METHOD FOR REDUCING ENERGY CONSUMPTION

(76) Inventors: Christina Ohman, Saltsjo-Boo (SE); Magnus Bang, Linkoping (SE); Alex Webb Allen, North Yorkshire (GB)

Correspondence Address: FASTH LAW OFFICES (ROLF FASTH), 26 PINECREST PLAZA, SUITE 2, SOUTHERN PINES, NC, 28387-4301, US

(21) Appl. No.: 12/529,843

(22) PCT Filed: Mar. 4, 2008
(86) PCT No.: PCT/US08/55748

§ 371 Date: Feb. 10, 2010

Related U.S. Application Data
(60) Provisional application No. 60/892,950, filed on Mar. 5, 2007.

(51) Int. Cl. G06Q 50/00; G06Q 30/00; G06Q 10/00; G06Q 20/00; G01R 21/00

(52) U.S. Cl. 705/14.31; 705/34; 705/412; 702/62

(57) ABSTRACT

The method is providing an energy saving service. Customers of a household participate in an energy saving service provided by a service provider. The household prepays an amount for energy consumption in a subsequent time period. The customers determine at an end of a time period whether actual energy consumption during the time period is less than a reference energy-consumption. The household is rewarded with service points corresponding to a difference between the actual energy consumption and the reference energy consumption.

### TECHNICAL FIELD

The present invention relates to a method for reducing energy consumption. More particularly, the method makes it easier for consumers to monitor their energy consumption. The consumers are rewarded when the consumption is reduced.

### BACKGROUND OF INVENTION

Almost every aspect of our lives depends on relatively cheap and uninterrupted supply of energy to our homes, businesses, industries and transports. However, increased pollution, greenhouse gas production and other problems related to increased use of energy cause difficult environmental problems. By monitoring energy and giving consumers an understandable feedback there is a potential for savings up to 25%. It is clear that there is a need to find methods to curb the increased consumption of energy. There is a need for an effective method that enables consumers to effectively monitor their consumption while providing incentives to save energy.

### SUMMARY OF INVENTION

The method of the present invention provides a solution to the above-outlined problems. More particularly, the method of the present invention is for providing an energy saving service. A household participates in an energy saving service provided by a service provider. The household prepays an amount for energy consumption to be used in a subsequent time period. The household may have its own account that is associated with the service. The household determines at an end of the time period whether actual energy consumption during the time period is less than a reference or planned energy-consumption. The household is rewarded with service points that correspond to a difference between the actual energy consumption and the reference energy consumption. The service points may be exchanged for products and services provided by companies that participate in the partnership of the service.

### BRIEF DESCRIPTION OF DRAWINGS

FIG. 1 is a schematic view of the system of the present invention;

FIG. 2 is a schematic view of a display of the system of the present invention; and

FIG. 3 is a schematic view of an information flow of the method of the present invention.

### DETAILED DESCRIPTION

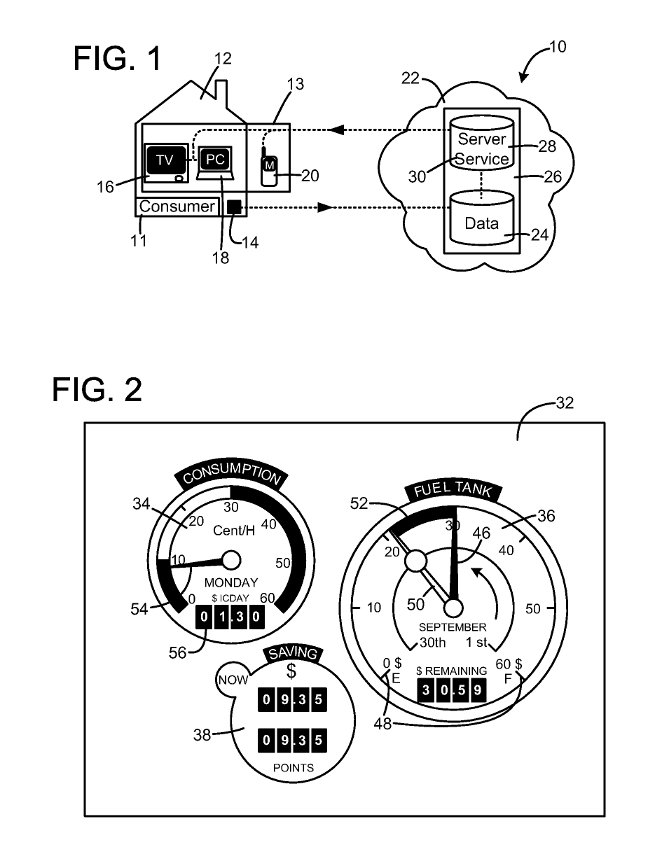

With reference to FIGS. 1-2, the method and system 10 of the present invention enable consumers 11 in a household 12 to effectively monitor and reduce energy consumption. Preferably, the home of the household 12 includes an automatic meter reading system 14. Additionally, the household 12 may have communication devices 13 that may include a television 16, a personal computer 18 and/or a mobile telephone 20. The reading system 14 may be installed in the home of the household 12. The automatic meter reading system 14 enables, among other things, energy suppliers and others to remotely access the energy consumption data of the household 12. The energy consumption data from the household may be sent via the Internet 22 to a centralized database 24 operated by the energy or service provider 26. The raw energy data may be processed and graphically represented by a service web server and presented on a website 28 as part of an incentive service 30 to enable the consumers in the household to monitor the energy consumption of the household. More particularly, the consumers of the household 12 may enroll and participate in the service 30 and may be required to pay a membership fee therefor.

A display 32, as best shown in FIG. 2, is available to the household 12 via any of the communication devices 13 that is connected via the Internet to the website 28. The display 32 graphically shows the energy consumption of the household 12. The display 32 may include a virtual consumption gauge 34, a virtual fuel-tank gauge 36 and a virtual savings gauge 38. At the end of the time period measured, such as at the end of the month, it is determined whether the actual energy consumption, as shown by an actual consumption indicator 46 in gauge 36, is less than a reference value 48. The reference value 48 may represent an amount of energy consumption that is desirable or planned for the time period. For example, the reference value 48 may represent the total amount of energy that has been pre-paid for. The gauge 36 indicates how actual consumption during the month, as shown by the indicator 46, compares to the planned-consumption rate, as shown by the indicator 50. In this way, the consumer can easily determine how actual consumption compares to the planned consumption to provide an incentive for the household to consume less energy than the reference value 48 as determined at the end of the month. The gauge 38 may thus be used to predict whether the energy already paid for will last for the entire month. The difference between the reference indicator 50 and the actual consumption indicator 46 is shown as a gray area 52. In the illustrated example, the gray area 52 corresponds to almost $10 in savings relative to the target or planned consumption. The exact amount is shown in the saving gauge 38 as $9.35 that may correspond to 9.35 points or any other suitable point value. At the end of the month, the gauge 38 shows how many points have been earned and their monetary equivalent value. It should be noted that the monetary value might only be transferable within the partnership scheme of the service 30.

The consumption-gauge 34 shows the daily consumption in real time as indicated by an indicator 54 (cents/hour) and a total daily consumption 56 (dollar value).

One important function of the display 32 is to motivate the consumers to reduce energy consumption by showing how much the actual consumption of the household 12 is below or above the reference consumption at a particular time. The system may also be set up so that the consumers receive a warning towards the end of the time period in one of the communication devices 13 when there is a risk that the household 12 is not going to go under the reference value 48. For example, a warning signal may be sent when only 10% of the fuel tank shown in gauge 36 is left and/or the actual consumption is more than the planned/reference consumption for the time period. The actual consumption is greater than the planned consumption when the indicator 46 is ahead of the reference indicator 50 in gauge 36. Such over-consumption may also be indicted in gauge 38 since the savings value and points are zero (or negative).

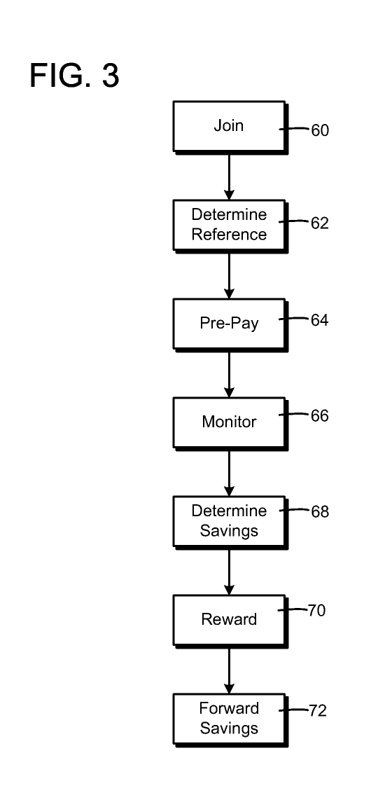

FIG. 3 is a schematic illustration of some of the steps of the method of the present invention. The consumers 11 in the household 12 first joins 60 the incentive service 30 by signing up for the service 30. The household is required to prepay 64 for the energy to be used over a specific time period such as for one month. The payment may be made directly on the website 28. The amount pre-paid corresponds to the reference value 48, such as $60 as shown in gauge 36.

It is possible to allow the consumers to decide how much to pre-pay. The required pre-paid amount may, for example, also be based on previous energy consumption, such as the energy consumption for the same month in the previous year. As a result, the energy supplier may allocate the specific amount of energy and this may reflect the average consumption in kilowatt-hours for the household 12 for a particular month. The required pre-paid amount may also be based on the energy-consumption by other households in the same community. The required pre-paid amount may also take into account the forecast out-door temperatures and other such factors. It is possible to make the system intelligent so that the user does not have to log in to obtain information. For example, the system may automatically alert the user via the mobile phone when there is a negative trend in the energy consumption so that the user is not saving as much energy as planned. It is also possible to use a web platform or a dedicated TV channel.

During the time period, the consumers in the household 12 may continuously monitor 66, in real time, the energy consumption of the household 12 by logging in to the website 28 to see the virtual display 32, as shown in FIG. 2. As indicated earlier, an important aspect of the service 30 of the present invention is that the household 12 may earn rewards for saving energy. The rewards may be exchanged for products and services. The service 30 enables consumers in the household 12 to accumulate their energy savings and reward points in a household account. More particularly, at the end of the time period, the amount of savings is first determined 68 by the value indicated in gauge 38. In other words, the reward 70 is preferably based on the amount indicated by the gauge 38 at the end of the time period such at the end of each month.

For example, the rewards may give the consumers 11 rights to discounts for various products and services that are offered by the companies and organizations that are active in the points partnership scheme of the service 30. The rewards may, for example, be related to discounted railway tickets or books. The rewards may also be donated to a charity. The consumers 11 may be able to increase the chances of being rewarded by increasing the amount pre-paid. The service provider may have the right to invest the pre-paid amount. Another motivating factor for companies to participate in and sponsor the service is that the companies gain access to the rapidly increasing number of energy conscious consumers. The image of the sponsoring companies may also improve by being associated with the energy-saving service 30.

The amount indicated by the gauge 38 at the end of the time period, may be advanced or forwarded 72 to the next time period so that the required pre-payment is reduced by the amount saved in the previous month. The amount saved may also be transferred to the household account for future use.

If there is nothing saved or the household has over-consumed, as, for example, indicated by the gauge 38, the household is not entitled to any rewards and will be required to pay for the over-consumption in the next time period so that the pre-paid amount for the next time period includes not only payment for the energy consumption in the next month but also payment for the overage from the previous time period. In the preferred embodiment, no penalty amount is forwarded to the next time period and the power supply should never be shut off even if the pre-paid amount is used up. However, it could be possible to impose some kind of penalty for over-consumption. Consumers that consistently over-consume may be excluded from the incentive service 30. It may also be possible to limit the amount the consumers can pre-pay to prevent the consumers from paying a very large amount and basically be guaranteed the rewards regardless of whether the consumers wastes energy or not.

While the present invention has been described in accordance with preferred compositions and embodiments, it is to be understood that certain substitutions and alterations may be made thereto without departing from the spirit and scope of the following claims.

1. A method of providing an energy saving service, comprising:
a household participating in an energy saving service provided by a service provider;
the household prepaying an amount for energy consumption in a subsequent time period;
using the prepaid amount to determine a reference energy consumption;
the household determining at an end of the time period whether actual energy consumption during the time period is less than the reference energy consumption; and
the household being rewarded with service points corresponding to a difference between the actual energy consumption and the reference energy consumption.

2. The method according to claim 1 wherein the method further comprises the household exchanging the service points for products or services provided by supporting companies.

3. The method according to claim 1 wherein the method further comprises the household continuously monitoring energy consumption in real time.

4. The method according to claim 1 wherein the method further comprises displaying the energy consumption with an actual consumption indicator and a planned consumption indicator in a virtual gauge available on a website.

5. The method according to claim 4 wherein the method further comprises displaying a total amount of saved energy in a gauge.

6. The method according to claim 1 wherein the method further comprises providing a home of the household with an automatic meter reading system that electronically sends energy consumption data to a web database.

7. The method according to claim 1 wherein the method further comprises forwarding rewarded energy points to a household account of the household.

8. The method according to claim 1 wherein the method further comprises forwarding rewarded energy points to a subsequent time period to reduce a required pre-paid amount for the subsequent time period.

9. The method according to claim 1 wherein the method further comprises displaying actual energy consumption relative to planned energy consumption in real time.
